(19) United States
(12) Patent Application Publication
(10) Pub. No.: US 2023/0090922 A1
(43) Pub. Date: Mar. 23, 2023

(54) MULTI-MATERIAL NOZZLE FOR CONCRETE ROBOTIC 3D PRINTING

(71) Applicants: Qatar Foundation for Education, Science and Community Development, Doha (QA); Qatar University, Doha (QA)

(72) Inventors: John-John Cabibihan, Doha (QA); Mohamed Medhat Radwan, Doha (QA)

(21) Appl. No.: 17/942,364

(22) Filed: Sep. 12, 2022

Related U.S. Application Data
(60) Provisional application No. 63/242,769, filed on Sep. 10, 2021.

(51) Int. Cl. B28B 1/00; B33Y 30/00; B33Y 80/00

(52) U.S. Cl. CPC B28B 1/001; B33Y 30/00; B33Y 80/00

(57) ABSTRACT

A printing device for concrete robotic 3D printing is provided. The printing device includes an inlet component, a collector component, and a nozzle. The inlet component includes a concrete inlet and a cleaning vent. The collector compartment includes an adapter and a metal collector assembly. The printing device further includes reinforcement bars, reinforced inner walls, and threaded metal inserts.

### CROSS REFERENCE TO RELATED APPLICATIONS

This application claims the benefit of U.S. Provisional Patent Application Ser. No. 63/242,769, filed Sep. 10, 2021, the contents of which is incorporated herein by reference in its entirety.

### BACKGROUND

3D printing (or “additive manufacturing”) is the construction of a three-dimensional object from a CAD or digital 3D model. It can be done in a variety of processes in which material is deposited, joined or solidified under computer control, with material being added, typically layer by layer. One of the key advantages of 3D printing is the ability to produce very complex shapes or geometries that would be otherwise impossible to construct by hand, including hollow parts or parts with internal truss structures to reduce weight. Fused deposition modeling (FDM), which uses a continuous filament of a thermoplastic material, is the most common 3D printing process in use as of 2020.

3D printing can be performed using a number of starting materials. For example, concrete 3D printing is an emerging technology for both research and industry, and typically involves:
a. A print head/nozzle is mounted onto a robot arm or gantry;
b. The print head/nozzle is connected to a pump with a hose pipe;
c. The components of the concrete material are mixed;
d. The mixed material is pumped into the print head/nozzle; and
e. “Lines” of the mixed material are extruded on top of each other.

The most challenging aspect of the process is the extrusion, and the printing head (i.e. nozzle) is one of the most important extrusion components. The nozzles help in regulating and directing the concrete flow before it flows out from the extruder. However, these printing heads are not accessible for prospective users in the industry or research, and the fabrication of such concrete printing heads is challenging. Therefore, innovation is needed to create concrete printing heads that are functional, simple, and easy to fabricate.

### SUMMARY

The present disclosure generally relates to printing devices such as print heads for robotic 3D printing, for example robotic 3D printing using cementitious materials such as concrete and other composite materials composed of fine and coarse aggregates bonded together with a fluid such as cement (cement paste) that hardens (cures) over time.

In light of the present disclosure, and without limiting the scope of the disclosure in any way, in an aspect of the present disclosure, which may be combined with any other aspect listed herein unless specified otherwise, printing devices for concrete robotic 3D printing are provided. The printing devices include, for example:
a. an inlet compartment;
b. a collector compartment; and
c. a nozzle.

In an aspect of the present disclosure, which may be combined with any other aspect listed herein unless specified otherwise, the printing device is composed of a 3D printed Polylactic Acid (“PLA”) polymer material.

In an aspect of the present disclosure, which may be combined with any other aspect listed herein unless specified otherwise, the inner walls of the printing device are reinforced with thin, inner metallic walls.

The reader will appreciate the foregoing details, as well as others, upon considering the following detailed description of certain non-limiting embodiments including a printing device for concrete robotic 3D printing according to the present disclosure.

### BRIEF DESCRIPTION OF THE FIGURES

FIG. 1 shows a concrete robotic printing head mounted on a robotic arm.

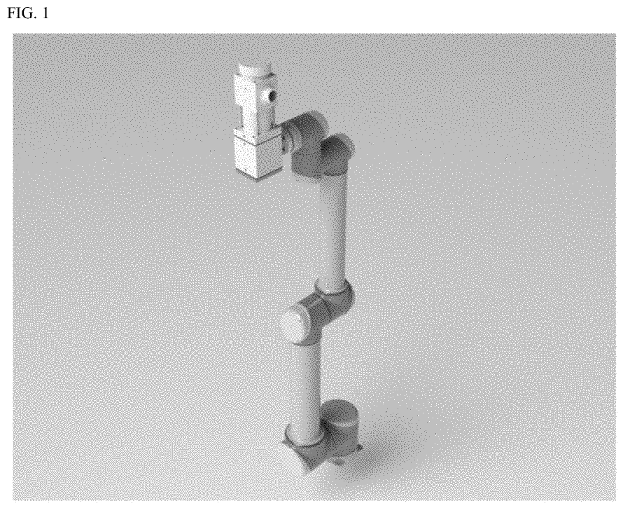

FIG. 2 shows concrete robotic printing head compartments.

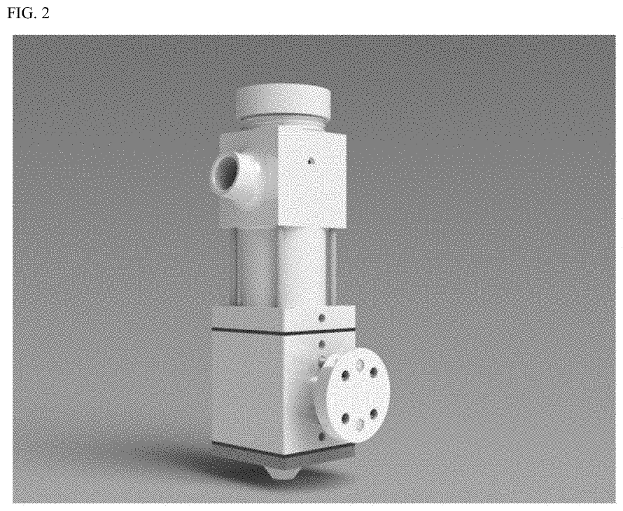

FIG. 3 shows a concrete robotic printing head reinforcements.

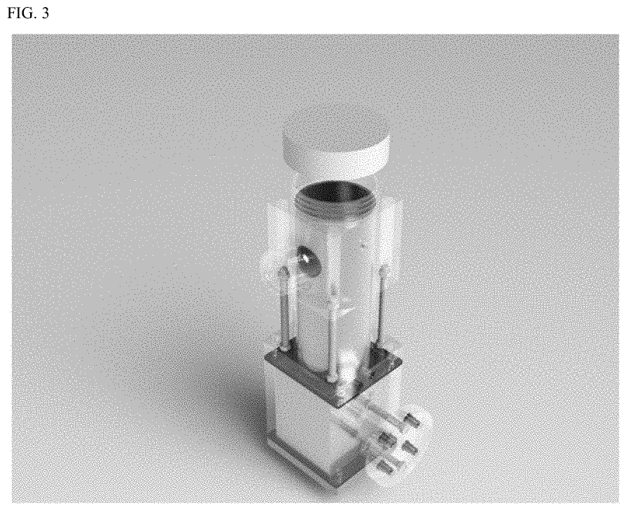

FIG. 4 shows the overall dimensions of an exemplary design in mm.

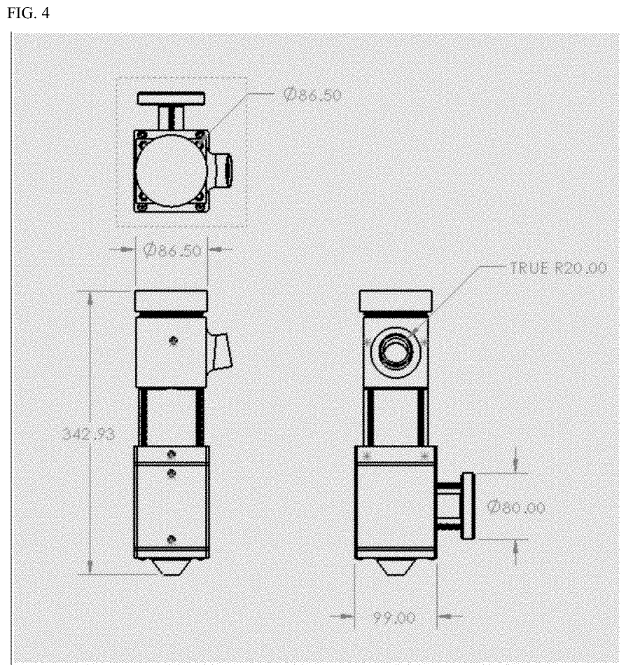

FIG. 5 shows a concrete robotic printing head with UR10 utilization.

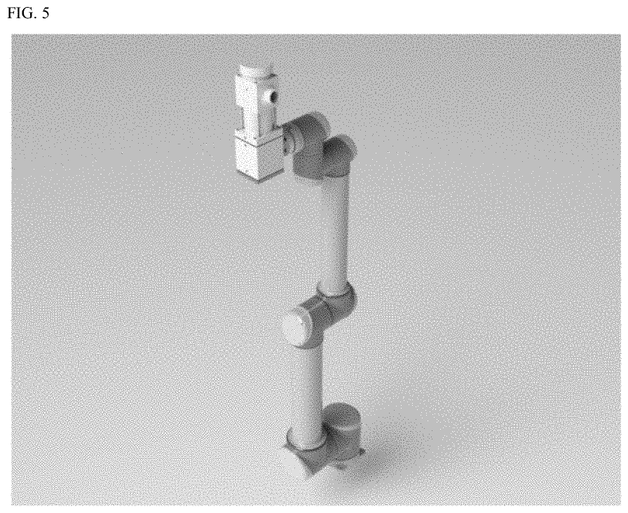

FIG. 6 shows prototype construction and evaluation.

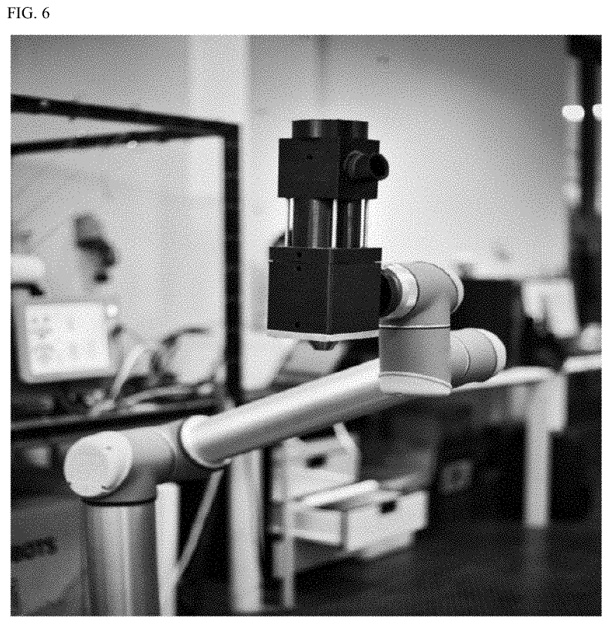

FIG. 7 shows an adapter for connection to the robot.

FIG. 8 shows the concrete inlet.

FIG. 9 shows the cleaning vent.

FIG. 10 shows reinforcement bars.

FIG. 11 shows reinforcement walls.

FIG. 12 shows threaded metal inserts.

FIG. 13 shows a metal collector assembly.

### DETAILED DESCRIPTION

The present disclosure generally relates to printing devices for robotic 3D printing, for example 3D printing using concrete materials.

Conventional robotic concrete printing devices include nozzle heads with various disadvantages. For example, there is no robotic concrete print head or nozzle that is made of 3D printed plastic in the market or in the research articles. Instead, all available designs include complex, expensive, and challenging fabrication techniques. Thus, the production and research of these conventional devices are complex and require many resources, which are passed on to the end consumer.

Aspects of the present disclosure may address the above-discussed issues in the conventional robotic concrete devices for 3D printing.

Systems and Components

According to an embodiment of the present disclosure, a printing device for concrete robotic 3D printing can comprise at least three different compartments: (1) an inlet compartment, (2) a collector compartment, and (3) a nozzle.

In embodiments, the inlet component is where the printing device first receives the raw material such as concrete from a pumping unit. In embodiments, the inlet component comprises an inlet, for example a concrete inlet, which is mechanically connected such as attached to a concrete pumping unit, and a cleaning vent. In embodiments, the cleaning vent comprises a large cap opening with a threaded cap, which gives access to the flow path for cleaning. In embodiments, the slope of the concrete inlet is such that the concrete from the pumping unit flows directly into the collector compartment.

In embodiments, the collector compartment is where concrete from the top inlet component is aggregated and directed into the nozzle. In embodiments, the collector compartment comprises an adapter and a metal collector assembly. In embodiments, the adapter connects the printing device to a robot. Further, in an embodiment, the adapter was designed according to the datasheet of the Universal Robot (UR10 model). However, the dimensions and geometry can be adjusted to suit any other robotic arm. In embodiments, the metal collector assembly is fixed on the nozzle to allow the flow of concrete throughout the compartments.

In embodiments, the nozzle receives concrete from the metal collector assembly and extrudes the concrete in a consistent shape. In embodiments, the nozzle comprises a 3D printed polymer material. For example, in embodiments, the nozzle comprises a plastic, for example a biodegradable plastic, such as Polylactic acid (“PLA”) polymer material.

Further embodiments can comprise reinforcement bars, reinforced inner walls, and threaded metal inserts. In embodiments, the reinforcement bars, which attach the inlet component to the collector component, provide further support for the components of the printing device. In embodiments, the reinforcement walls comprise thin metal inserts that line the inside of the printing device. These walls reinforce the design and allow concrete to flow more easily throughout the design. In embodiments, the printing device's holes are reinforced with threaded metal inserts, which increase joint strength and allow metal to metal contact at the threads. For example, in embodiments, the adapter, which connects the collector compartment to the robot, comprises holes that comprise threaded metal inserts.

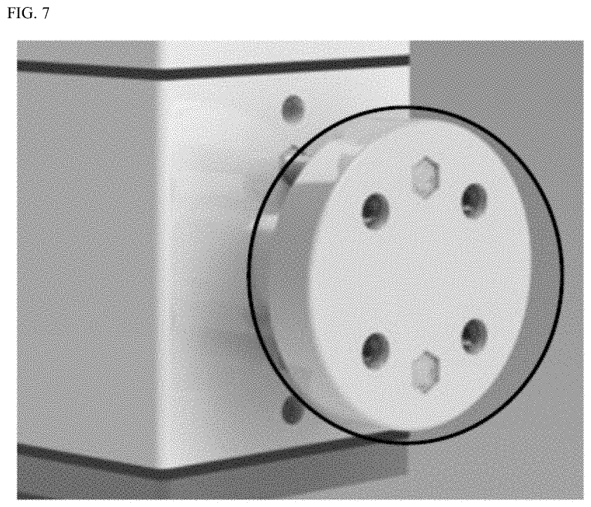

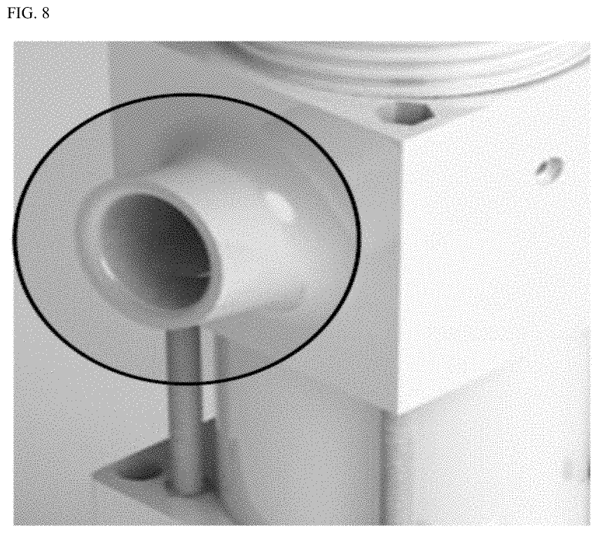

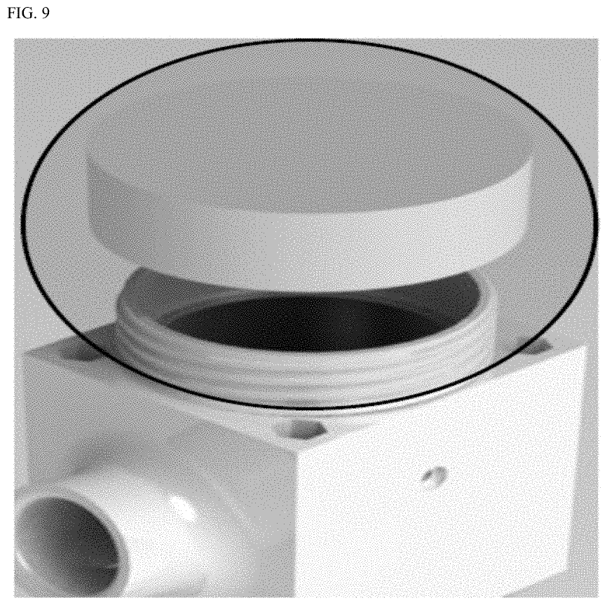

As shown in FIG. 7, an adaptor is provided. In embodiments, the adaptor is designed according to the specifications of the robot, typically as provided by the manufacturer. In embodiments, the holes are reinforced, for example with metal inserts. FIG. 8 shows the concrete inlet, designed with a slope appropriate to maintain flow into the collector. The cleaning vent is shown in FIG. 9. The vent comprises an opening with a threaded cap that provides direct access to the flow path.

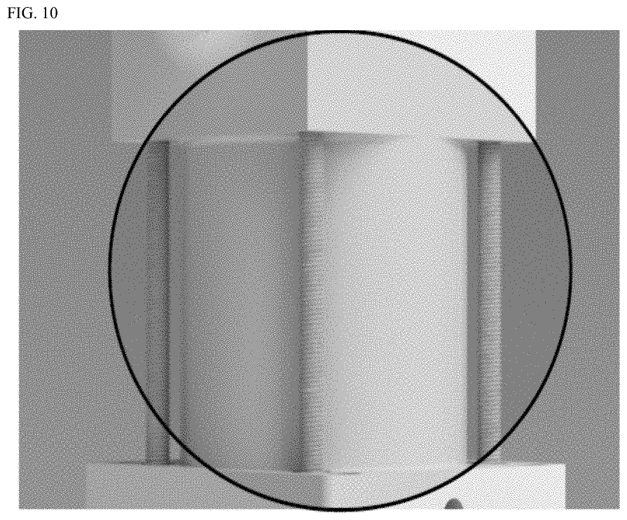

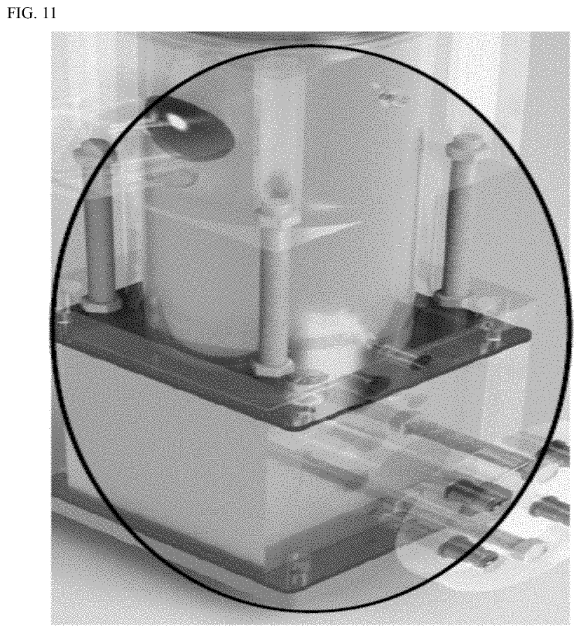

FIG. 10 shows metal reinforcement bars, though any appropriate material can be used. These bars can, in embodiments, support other aspects such as the adaptor. FIG. 11 shows reinforcement walls. In embodiments, the reinforcement walls are metal though other appropriate materials can be used. These bars reinforce the inner geometry of the system to allow for better contact with the flow path.

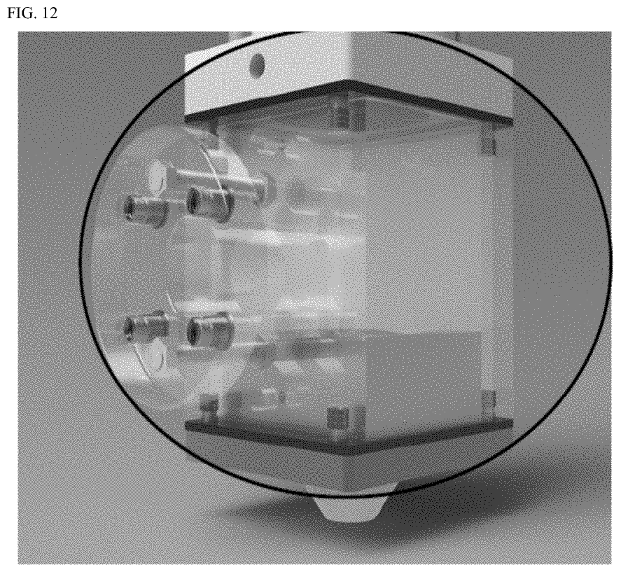

FIG. 12 shows threaded metal inserts through holes in the system. In embodiments, the inserts are metal though other appropriate materials can be used. The inserts increase joint strength throughout the system and provide for metal-to-metal contact at the threads.

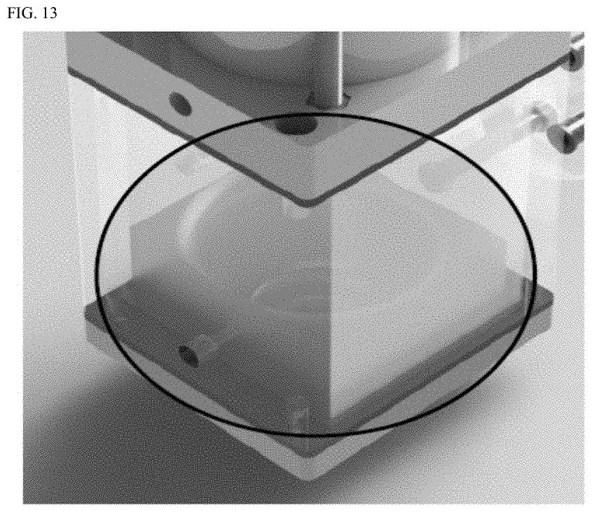

FIG. 13 shows the collector. In embodiments, the collector is designed and fixed on the nozzle to provide increased flowability throughout the system components.

### METHODS OF USE

Disclosed embodiments comprise methods of use of the systems, devices, and components disclosed herein. For example, disclosed methods can comprise computer-aided design (“CAD”) to design and produce 3D-printed concrete structures.

Further embodiments comprise the use of CAD to design and produce a print head for use in 3D printing, for example concrete 3D printing. In embodiments, the print head for use in 3D printing is itself 3D printed, for example from a polymer material such as PLA.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A 3D printing device comprising:
an inlet component;
a collector component; and
a nozzle.

2. The printing device according to claim 1, wherein said nozzle is 3D printed.

3. The printing device according to claim 2, wherein said nozzle is composed of polylactic acid.

4. The printing device according to claim 2, wherein said inlet component comprises a concrete inlet and a cleaning vent.

5. The printing device according to claim 1, wherein said collector compartment comprises an adapter and a metal collector assembly.

6. The printing device according to claim 1, further comprising a plurality of reinforcement bars.

7. The printing device according to claim 1, further comprising a reinforced inner wall.

8. The printing device according to claim 1, wherein said device is for printing concrete.
